(19) United States
(12) Patent Application Publication
(10) Pub. No.: US 2006/0182093 A1
(43) Pub. Date: Aug. 17, 2006

(54) VOIP gateway network

(76) Inventors: Alfred R. Nurnberger, Portland, OR (US); Ryan James Mitchell, Portland, OR (US); Jared Vincent Boone, Portland, OR (US); Carl H. Spiegelberg, Yakima, WA (US); Craig E. Spiegelberg, Washougal, WA (US)

Correspondence Address: Timothy E. Siegel, Suite 206, 1868 Knapps Alley, West Linn, OR, 97068-4644, US

(21) Appl. No.: 11/367,938

(22) Filed: Mar. 3, 2006

Related U.S. Application Data
(63) Continuation-in-part of application No. 11/160,225, filed on Jun. 14, 2005.
(60) Provisional application No. 60/654,328, filed on Feb. 17, 2005.

(51) Int. Cl. H04L 12/66

(52) U.S. Cl. 370/352; 370/401

(57) ABSTRACT

A method of connecting a telephone call to a first telephone having a first telephone number that begins with automatically placing the telephone call to a VOIP gateway PABX having a second telephone number. The first telephone number is forwarded to the VOIP gateway PABX and the call is forwarded by way of the VOIP gateway PABX over a least cost route to the first telephone having the first telephone number.

### RELATED APPLICATIONS

This application is a Continuation-in-Part of application Ser. No. 11/160,225, filed on Jun. 14, 2005, which claims priority from Provisional Application Ser. No. 60/654,328 filed on Feb. 17, 2005.

### BACKGROUND OF THE INVENTION

Voice-Over-Internet Protocol (VOIP) telephony has become increasingly popular because it is generally less expensive for the party placing a telephone call than alternative systems. Accordingly, several vendors have begun offering VOIP “gateways,” that is electronic devices for assembling packets of data from the Internet to create a voice signal, and for receiving a voice signal and creating a sequence of data packets that are sent over the Internet to a destination.

Unfortunately, it has proven very difficult to create a VOIP gateway that may be easily configured and put into service by someone other than a professional trained in an arcane computer language. Many of the configuration choices do not occur in other environments, so most users are not familiar with the terms that can be used to describe these choices. This problem has slowed the adoption of VOIP technology.

In addition, generally available VOIP gateways typically have no way to direct calls to different channels of a T1 line depending on the characteristics of the telephone number entered. This presents a difficulty to the user who wishes to handle different T1 line channels, or groups of channels differently from others.

Also, there appears to be currently no gateway that translates VOIP data packets directly into wireless telephone encoded signals. Wireless telephony, however, is increasingly popular. Moreover, in many situations the least cost strategy for terminating a long distance telephone call to a wireless telephone is to terminate by way of a wireless unit that is registered with the same carrier as the wireless telephone being called.

Currently, many cell phones have a feature known as “Push-to-Talk over Cellular” or “PoC,” in which a first cell phone may activate a second cell phone and establish a link between the two so that subsequently merely pushing a button on either cell phone opens up the channel with the other, with no need for “answering” the other cell phone. It appears, however, that there is currently no way of achieving the same end with a land line.

An additional facet of the modern world is that small to medium sized business, such as real estate offices and other sales offices frequently have high telephone bills. Typically, each salesperson is issued a cell phone by the office and he frequently uses this cell phone to call clients, some of whom may have telephone numbers that it is quite expensive to connect with directly. Although the ability to stay in touch with clients may be absolutely crucial to salesmen, thereby justifying the expense of the resultant cell phone bill, many small businesses would welcome some way to reduce this expense.

Part of the expense of using a first cell phone in the field is that calls placed to land lines or to a cell phone serviced by a provider other than that of the first cell phone are billed at a higher rate than calls to a cell phone serviced by the same service provider.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In a first separate aspect, the present invention takes the form of a method of connecting a telephone call to a first telephone having a first telephone number that begins with automatically placing the telephone call to a VOIP gateway private automated branch exchange (PABX) having a second telephone number. The first telephone number is forwarded to the VOIP gateway PABX and the call is forwarded by way of the VOIP gateway PABX over a least cost route to the first telephone having the first telephone number.

In a second separate aspect, the present invention takes the form of a method of doing business that includes controlling a VOIP gateway connected to a public switched telephone network (PSTN) in a first location and providing a VOIP gateway PABX at a second location. The VOIP gateway is controlled to forward over the Internet telephone calls from the PSTN to the VOIP gateway PABX.

In a third separate aspect, the present invention takes the form of a call forwarding system for a first telephone number wherein a user may specify a second telephone number to which calls should be forwarded if and only if no connection can be established on the first telephone number.

In a fourth separate aspect, the present invention takes the form of a voice mail message system wherein voice mail messages are recorded in voice mailboxes at a location remote from a user telephone, and wherein a user may listen to a message being recorded in his mailbox.

In a fifth separate aspect, the present invention takes the form of a method of quickly expanding a PABX network that includes wireless transceivers, comprising providing a wireless handset connected to the PABX by way of the wireless transceivers.

In a sixth separate aspect, the present invention takes the form of a long distance service for transient tenants, comprising a set of telephony handsets connected to a VOIP PABX.

In a seventh separate aspect, the present invention takes the form of a method of transferring a telephone call, comprising, linking the telephone call to a set of entries in a computer database and transferring the telephone call together with a pointer to the entries.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a functional block diagram of the operations performed by a VOIP to wireless gateway according to the present invention.

FIG. 2 is a block diagram showing the components of the VOIP to wireless gateway of FIG. 1.

FIG. 3 is an illustration of a VOIP gateway system according to a preferred embodiment.

FIG. 4 is a flow diagram illustrating an emergency call forwarding method, according to an additional preferred embodiment.

FIG. 5 is a block diagram illustrating a cell phone rate saving method, according to another additional preferred embodiment.

FIG. 6 is an illustration of a long distance access method, according to another additional preferred embodiment.

FIG. 7 is an illustration of a sales call transfer method, according to another additional preferred embodiment.

### DETAILED DESCRIPTION OF THE PREFERRED EMBODIMENT(S)

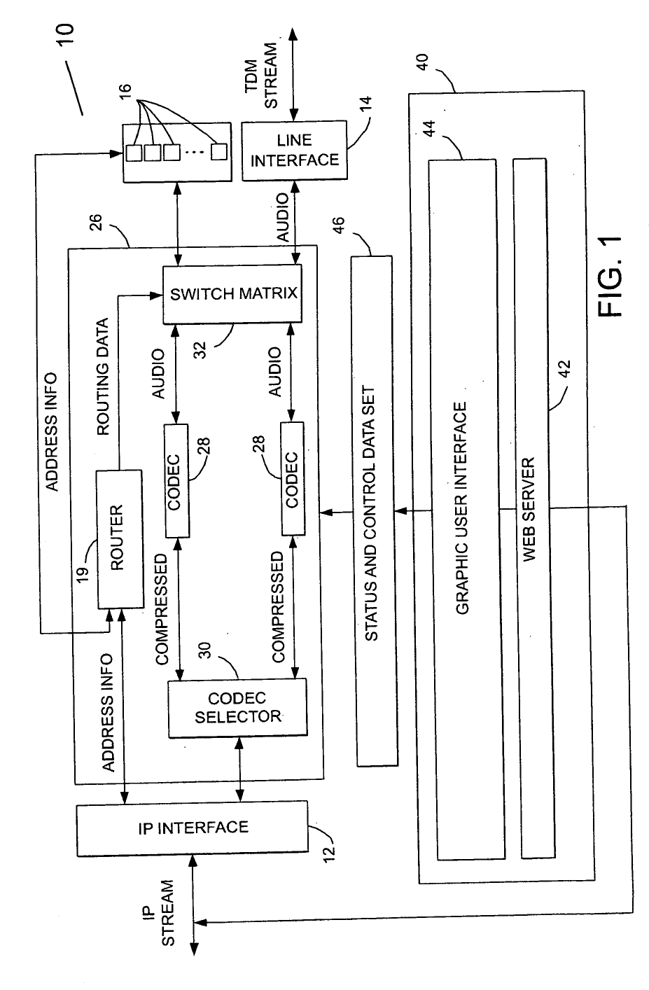

Referring to FIG. 1, which illustrates the workings of a VOIP gateway in broad functional blocks, a VOIP gateway 10 according to the present invention, includes an internet protocol (IP) interface 12, which would typically be connected to a DSL line, or a cable modem. In one preferred embodiment (IP) interface 12 is a wireless data line port forming a broadband wireless connection, for example an EVDO line. Also a standard telephony line interface 14 which is typically connected to T1 lines, if the gateway 10 is being used in the United States. If the gateway 10 is placed in use in Europe or another place using the European standard, E1 lines would be used. For Japan and other places using the Japanese standard, a J1 line would be used. In an alternative preferred embodiment, gateway 10 includes additional functional blocks that permit it to serve as a private automated branch exchange (PABX). In addition to telephone line interface 14, a bank of wireless transceivers 16 is available for terminating telephone calls incoming from port 12.

A signal routing and processing block 26, includes a set of codecs 28 and a codec selector 30, which compress the voice data and decompress the internet data, according to which way the data is directed. This is all done in accordance with already well known principals, so it is not described here. A switch matrix 32, connects each call incoming from interface 12 to a T1 line channel of interface 14 or a wireless transceiver 16.

Turning now to wireless transceivers 16, each of which is essentially the electronics of a cell phone, as the mouth piece, speaker and key pad of a cell phone are all unnecessary. One international standard for cell phone systems, Global System for Mobile Communications (“GSM”) is used by over a billion cell phone subscribers in more than 200 countries. This standard specifies the use of a subscriber identity module (“SIM chip”), which is removable and bears the telephone number that one must call to reach the cell phone. This scheme permits a cell phone user to dispose of an old cell phone and transfer his telephone number to a new cell phone without having to contact and arrange the matter with his service provider. Other standards also specify the use of a SIM chip.

Also, in Europe and other areas it is very easy to tell which telephone numbers are associated with which wireless service provider because each wireless service provider is assigned a particular area code. In many regions preferential pricing is provided for telephone calls placed between wireless accounts that both belong to the same service provider. Accordingly, there is an advantage to terminating any call arriving over IP interface 12 by way of a wireless unit that self identifies as being part of the network of the service provider to which the called telephone number belongs.

Accordingly, at least some wireless transceivers 16 are constructed to accept a SIM chip. In this manner the user of gateway 10 may change his assignment of cell modules to wireless service providers. In addition, some SIM chips provide an indication of an amount of prepaid wireless time, potentially simplifying wireless provider billing. The use of wireless transceivers that accept SIM chips may be useful, for example, if one wireless service provider gains popularity over another. Not every wireless service provider, however, supports cell phones that use SIM chips. For example cell phones that use a code division multiple access (CDMA) protocol typically do not include a SIM chip. Accordingly, some cell modules 16, for example CDMA modules, or modules using a protocol not yet developed, would typically be supplied as registered cell phone equivalents.

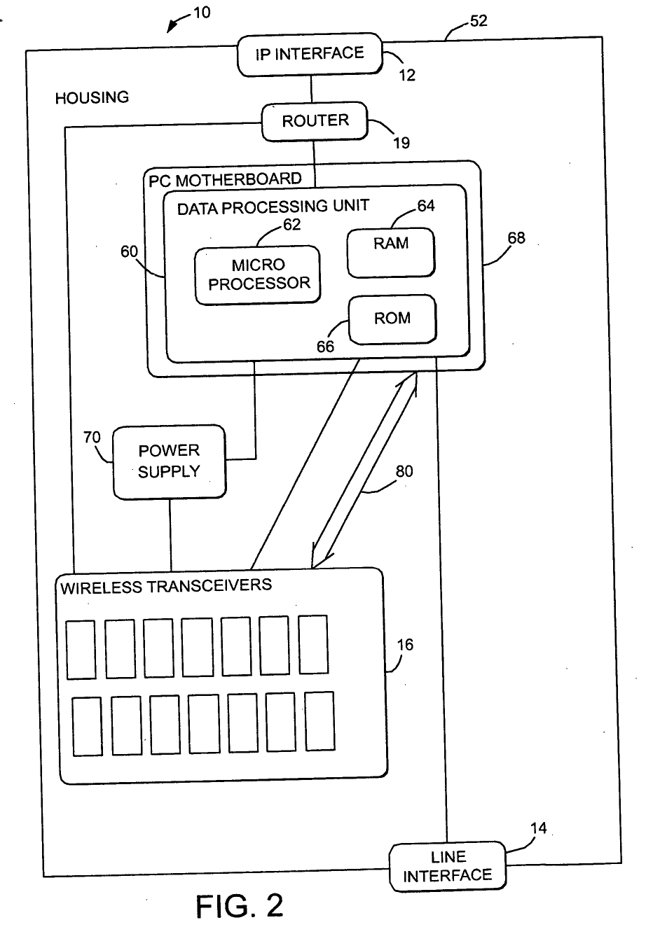

A nonvolatile memory assembly 40, a webserver 42 and a graphical user interface memory 44, which includes the information necessary to display a graphical user interface for guiding a new user through a set-up procedure and for facilitating later adjustments to the operation of gateway 10. This process is used to create a status and control data set 46, which is used to control data processing unit 60 (FIG. 2).

Many of the screen displays of the graphical user interface (GUI) are presented in U.S. patent application Ser. No. 11/038,975, filed Jan. 19, 2005, which is hereby incorporated by reference as if fully set forth herein. In general, the GUI permits a user to configure the system so that telephone calls arriving over digital port 12 are routed in the least cost manner. For example, a telephone call terminating at a cell phone supported by a particular service provider would be recognized (either by the area code of the called telephone number or the prefix) and would be terminated as a telephone call over a wireless transceiver 16 also associated with that service provider.

In addition to accepting user input, the configuration process is facilitated by the gateway 10 system ability to gather information from the lines (either physical PSTN connections or logical VOIP connections) to which it is connected and set various parameters automatically, thereby easing the task of the personnel assigned to the configuration task. For example, in one preferred embodiment 10, the system monitors line performance, ranks the various lines and takes into account line quality when assigning each incoming call to a line. This innovation was made possible by insight into the systems engineering aspects of the design.

Turning now to the structural block diagram gateway 10 shown in FIG. 2, a single housing 52 covers and protects both the wireless transceivers 16 and a data processing unit 60, which performs the functions of the codec selector 30 , the codecs 28 and the switch matrix 32. By placing the data processing unit 60 and the wireless transceivers 16 in the same physical unit, which a single housing 52, greater manufacturing efficiency is achieved then in the prior art, in which these units were separate. In an alternative preferred embodiment, transceivers 16 and data processing unit are physically separated and in different housings, although fully functionally integrated, so that transceivers 16 may be located in a place having good wireless reception, independent of the placement of data processing units 60.

Unit 60 is communicatively connected to the bank of wireless transceivers 16 by way of a standard computer bus 80, such as a peripheral component interface (PCI) bus, a FireWire bus (also known as an i.Link or IEEE 1394 bus), or a universal serial bus (USB). In a preferred embodiment, data processing unit 60 is resident on a PC motherboard 68, which is the standard term for the type of motherboard found in an IBM style PC. The use of standard buses and components greatly facilitates assembly and use of the preferred embodiment.

Unit 60 also causes the display of the graphic user interface 44, which prompts a user to enter configuration data during set-up and receives and stores the status and control data set 46. In the prior art, a unit having a bank of wireless transceivers had to be configured separately from the VOIP gateway with which it cooperated. The GUI of the preferred embodiment, however, guides a user through a configuration routine for both the data processing unit 60 and the bank of wireless transceivers 16 in a single communicative and temporal connection. This results in a great user convenience.

Additionally, the data processing unit 60 performs the higher level control functions for itself and for the wireless transceiver bank 16. For example, the task of selecting between functionally equivalent wireless transceivers 16 for terminating a telephone call arriving on port 12 is performed by data processing unit 60. In the prior art this task was performed by a mechanism on a physically separate cell module bank unit. Also, the translation of called telephone number arriving on interface 12, into a form understandable by transceivers 16 is performed by unit 60. The ability to have unit 60 control both the wireless transceivers 16 and the VOIP gateway functions represents an efficiency in the gateway 10 over previous configurations in which the gateway 10 and the bank of wireless transceivers 16 were separate. Data processing unit includes a microprocessor 62, random access memory 64, for storing voice and internet protocol (IP) data, and read only memory 64, in which the control functions and the graphical user interface information are stored.

A power supply 70, supplies DC power at the correct voltages to both the wireless transceivers 16 and the data processing unit 60. It is an efficiency of the present embodiment that a single power supply 70 supplies both the data processing unit and the wireless transceivers 16.

In an additional feature, a predetermined signal entering from a particular telephone line of the standard telephony line interface 14 can be used to open a push to talk over cellular, by way of a wireless transceiver 16, with a designated wireless telephone. It is anticipated that gateway 10 may be connected to a private automated branch exchange (PABX) and that this feature will permit a land line user in a facility using the PABX to establish a PoC connection with a wireless telephone, which could in some circumstances greatly ease a communicative task.

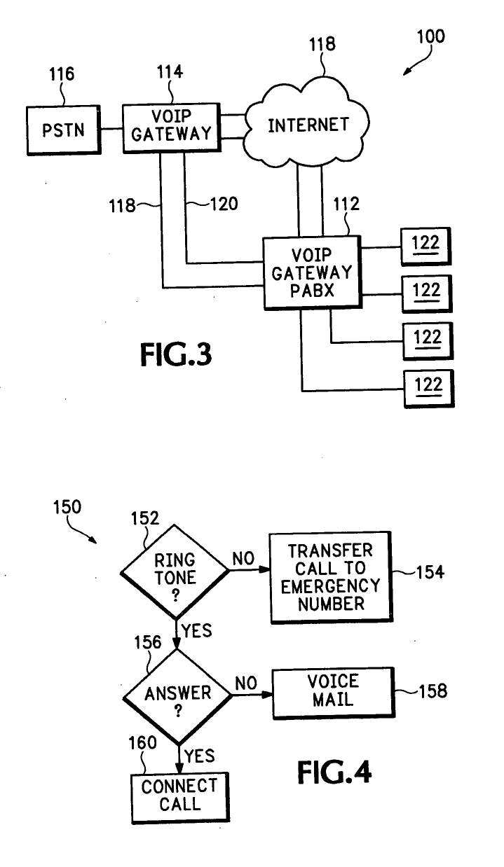

Referring to FIG. 3, a preferred embodiment of a voice over internet protocol (VOIP) gateway system 100 includes a VOIP gateway private automated branch exchange (PABX) 112, having a VOIP gateway portion similar to gateway 10, and a VOIP gateway 114, also similar to gateway 10, that is connected to a public switched telephone network (PSTN) 116. PABX 112 and gateway 114 are connected at least over the Internet, as each is connected to the Internet by way of a router. In a preferred embodiment, each also includes wireless transceivers, permitting a wireless link 118. Units 112 and 114 may also be connected by one or more PSTN lines 120. Gateway 114 may be located in an area code other than that of PABX 112. Individual telephones 122 are connected to VOIP gateway PABX 112. In this application, the term “Internet,” when capitalized, means the public Internet which connects a large number of the world's computers. When not capitalized, the term “internet” means any network that operates on the basis of internet protocol, or IP. PABX 112 and gateway 114 may also be connected by one or more private internets.

System 100 may find application for use as a calling center or a call receiving center (“call center”). Rather than listing a toll free number, the call center operator can list a number having the local area code in both the location of the PABX 112 and the location of the gateway 114. Those wishing to telephone the call center from the area code of the gateway 114 would dial the number having the area code of gateway 114 and their telephone calls would be sent by way of the Internet to PABX 112.

One problem with this method is that the operator of PABX 112 and gateway 114 does not have control of the internet route taken between gateway 114 and PABX 112. Accordingly, the information sent over the Internet may proceed along a circuitous route that increases transmission time. This can lead to gaps in the sound transmission, leaving a bad impression on the caller. To combat this problem both gateway 114 and PABX 112 may be connected to the Internet by way of at least two different routes and may periodically check calls starting from each route by placing dummy telephone calls back and forth, to determine the best route for sending out telephone calls. When an actual telephone call must be placed, it is placed by the route that has been found to create the most direct connection.

Typically, the use of different routes requires the use of different Internet Service Providers. In one instance the local cable company, the local telephone company and a long distance telephone company are all used and a comparison between the various service providers is periodically made. These comparisons may take place, for example, every few seconds.

The wireless link 118 between PABX 112 and gateway 114 may become extremely important in the event that all of the land lines to PABX 112 are somehow cut. This does happen occasionally, for example because some piece of construction equipment has physically severed a fiber optic cable. This loss of telephone service would represent a disaster for many sales offices and call centers. The wireless link 118, however, could be used to continue to forward telephone calls to the PABX 112. In addition the wireless link 118 or a PSTN line 120 could be used to forward telephone calls in the event that no Internet link was found to be of high enough quality for forwarding telephone calls. Although these options would be expensive, if only infrequently used the PABX 112 owner could still save money, while maintaining consistently good call quality.

In one preferred embodiment, a user guide and other documentation on paper or on electronic (i.e. magnetic, optical) media or both are associated with the system 100. The user guide explains how to set up and use the system 100 to the uninitiated. The electronic media includes short movies showing an operator using the system 100. Other documentation includes a trouble shooting guide for system 100. Moreover, PABX 112 and gateway 114 maintain logs which are used to increment the documentation, based on actual system experience.

Even in a standard telephony system, it would be possible to forward calls to a second, emergency, telephone number in cases were the lines had been cut, if it were possible to forward telephone calls to a specified number if and only if no connection could be established for a first telephone number. Referring to FIG. 4, for users who wish to have their telephone calls forwarded when the first number is not answered, this is possible now. But many users may wish to have their voice mail system answer telephone calls when the first telephone number is not answered. Referring to FIG. 4, these users would need a service that would forward telephone calls placed to the first number if and only if no connection could be established (decision box 152 and block 154 of logic sequence 150), in order to create an emergency forwarding to a second telephone. This second telephone could be a wireless telephone, which would not be affected if the land lines were cut (for example in a back hoe mishap). If a connection could be established, the telephone call would be handled in the ordinary manner (decision box 156 and blocks 158 and 160).

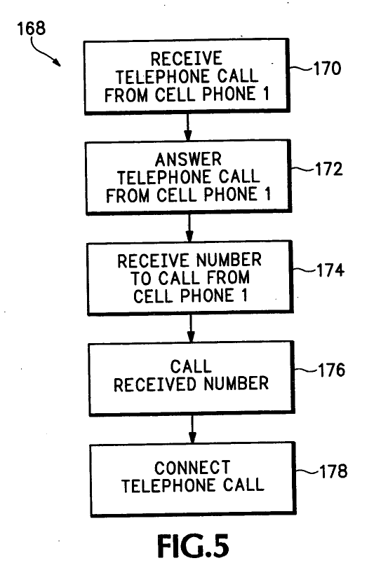

Referring to FIG. 5, The PABX 112 (FIG. 3) also permits a cell phone user to save on cell phone charges by having his telephone calls directed to go through the PABX 112 (sequence 168). To achieve this effect, a cell phone is needed, which can call the PABX 112 (block 170) and after PABX 112 answers the call (block 172), transmit a further telephone number to the PABX 112 (block 174), representing the party to whom the cell phone user actually wishes to speak. The PABX 112 places a telephone call to this number (block 176) over the least cost route and connects the cell phone to the called party (block 178) by way of a first link from the cell phone to the PABX 112 and a second link from the PABX to called party.

In one preferred embodiment a specially configured cell phone automatically directs all telephone calls to the PABX 112 without human intervention. A cell phone can be configured in this manner by setting up a java client or an interactive SIM card to automatically proceed through the steps. That is to say, the user simply enters a first telephone number and the cell phone automatically telephones the PABX 112 (at a second telephone number) and forwards the first telephone number to the PABX 112 which continues with the process as described above. In another preferred embodiment, the cell phone includes a speed dial function which indicates that the telephone call should go through the PABX 112, so that the user would press the speed dial button and enter the first telephone number. In yet another preferred embodiment an existing button (such as the asterisk key) is assigned the function of routing calls through the PABX 112.

In one preferred embodiment, a user guide and other documentation on paper or on electronic media or both are associated with the PABX 112. The user guide explains how to set up and use the system to the uninitiated. The electronic media includes short movies showing an operator using the PABX 112. Other documentation includes a trouble shooting guide.

In somewhat related technology, many telephone system users may wish to listen to messages that are being left on the user's remote voice mail. This permits a user to screen calls, by listening to find who is leaving the telephone call and then answering if the user wishes to speak to the caller. This system innovation may be easily implemented by automatically establishing a conference call between the remote voice mail station, the caller and the call recipient, with the call recipient's telephone automatically muted. A button on the call recipient's telephone, such as the asterisk or pound key, would automatically end the muting and the conference call, placing call and called party directly in voice contact when pushed.

In some companies, some employee work stations are equipped with cell phones. This may happen because the company has expanded into an area of its building (or into an additional building) in which there is no hardwired connection to the PABX, and the fastest way to accommodate the new employees is to provide them with cell phones to use. This is sometimes referred to as a “cell island.” Unfortunately, this practice can prove quite expensive, as a telephone call from that employee to another employee whose telephone is connected to the PABX must be switched through the cell phone provider to a land line, which is typically a fairly expensive termination. With PABX 112, which has cellular transceivers, a telephone call from a cell phone equipped employee may be handled in the same manner as that of a cell phone in the field. New employees may be easily accommodated, without undue expense, by being provided with a cell phone that automatically routes its calls through the PABX. Alternatively, the PABX could include some cordless transceivers for rapid system expansion at places near to the PABX.

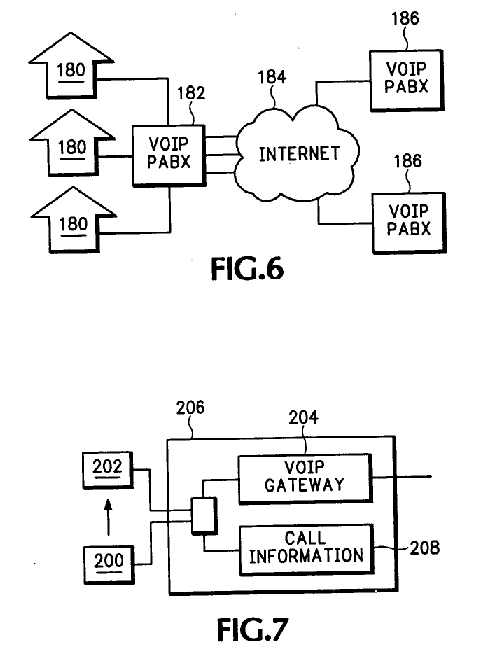

In the rental housing market there is a system for permitting rental housing owners to provide long distance telephone service to house renters. This service is sometimes provided for a flat fee to the rental house owner, with the idea that it makes his rental house more attractive to prospective renters. Referring to FIG. 6, in one preferred embodiment of the present invention, a number of rental houses 180 in a local area are all connected to a VOIP PABX 182, which is connected through the Internet 184 to a terminating set of VOIP gateways 186. This permits the long distance service to be offered but costs the unit owner less than if a PSTN was used for the same task.

Referring to FIG. 7, in a sales situation, a sales person at a first station 200 may wish to transfer a telephone call to another sales person at a second station 202. For example in the rental housing market, a first sales agent station 200 who is arranging for the rental may, after the rental transaction is completed, wish to transfer the telephone call to an agent station 202 who sells trip insurance. This sort of transfer can be easily accomplished by way of a VOIP PABX 204, because the PABX may be incorporated on a computer 206 that can accept the number to which the telephone call will be transferred. This technology is particularly helpful if it is desired that the second sales person be able to view information collected by the first sales person and held in a data storage area 208. A data object identifies or points to the part of the data storage area 208 in which the call information is held, as well as identifying the PABX information associated with the telephone call. When the telephone call is transferred from the first sales person to the second sales person, a program in the PABX computer, being informed of the transfer of the telephone call, displays the information collected by the first sales person on a display device associated with the telephone of the second sales person, permitting him to view, for example, the dates of arrival and departure, unit rented, etc. while he is entering into his sales presentation.

It should be emphasized that although in some places in this specification the use of a “cell phone” is noted, this includes all the new technologies that are now being increasingly adopted, including Wi-Fi and WiMax communications. For example, it may be possible for salespeople to use a WiMax phone in the city in which their office is located. This may prove advantageous relative to a cell phone.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method of connecting a telephone call to a first telephone having a first telephone number, comprising:
(a) automatically placing said telephone call to a VOIP gateway PABX having a second telephone number;
(b) forwarding said first telephone number to said VOIP gateway PABX; and
(c) forwarding said call by way of said VOIP gateway PABX over a least cost route to said first telephone having said first telephone number.

2. The method of claim 1 wherein step (a) is performed by a specially constructed telephone.

3. The method of claim 1 wherein said specially constructed telephone redirects telephone calls to telephone numbers having shared characteristics.

4. The method of claim 1 wherein said specially constructed telephone redirects calls to which a unique prefix or suffix is appended by a user.

5. A method of doing business, comprising:
(a) controlling a VOIP gateway connected to a PSTN in a first location;
(b) providing a VOIP gateway PABX at a second location; and
(c) using said VOIP gateway to forward over the Internet telephone calls from said PSTN to said VOIP gateway PABX.

6. The method of claim 5, wherein said VOIP gateway is in a different area code then said VOIP gateway PABX.

7. The method of claim 5, further comprising controlling additional VOIP gateways.

8. The method of claim 8, wherein said additional VOIP gateways are in area codes different from the area code in which said VOIP gateway of claim 1 is located.

9. The method of claim 8, wherein a said controlled VOIP gateway is located in at least a significant subset of the area codes in the United States.

10. The method of claim 8, wherein at least one said controlled VOIP gateway is located in a country outside of the United States.

11. The method of claim 5, wherein said VOIP gateway is connected to more than one Internet route.

12. The method of claim 11, wherein said VOIP gateway at least occasionally tests said Internet routes to determine which one offers the best connection to said VOIP gateway PABX.

13. The method of claim 5, wherein said VOIP gateway, if it detects that every route has performance degraded below an acceptable level, routes calls to said VOIP gateway PABX through a PSTN line.

14. The method of claim 5, wherein said VOIP gateway and said VOIP gateway PABX both are connected to wireless telephone lines.

15. The method of claim 14, wherein said VOIP gateway, if it detects that every Internet route has performance degraded below an acceptable level, routes telephone calls to said VOIP gateway PABX by way of said wireless telephone lines.

16. The method of claim 14, wherein said VOIP gateway, if it detects that every Internet route has performance degraded below an acceptable level and that all PSTN communication with said VOIP gateway PABX is unavailable, routes calls to said VOIP gateway PABX through said wireless telephone lines.

17. The method of claim 5 wherein said VOIP gateway and said VOIP PABX are also connected by way of a private internet.

18. A call forwarding system for a first telephone number wherein a user may specify a second telephone number to which calls should be forwarded if and only if no connection can be established on said first telephone number.

19. A voice mail message system wherein voice mail messages are recorded in voice mailboxes at a location remote from a user telephone, wherein a user may listen to a message being recorded in his mailbox.

20. A method of quickly expanding a PABX that includes wireless transceivers, comprising providing a wireless handset connected to said PABX by way of said wireless transceivers.

21. A long distance service for transient tenants, comprising a set of telephony handsets connected to a VOIP PABX.

22. A method of transferring a telephone call, comprising, linking said telephone call to a set of entries in a computer database and transferring said telephone call together with a pointer to said entries.

23. A VOIP gateway, connected to a set of telephone lines, and wherein said VOIP gateway senses aspects of line (either of physical phone lines or logical VOIP connections) quality for each line and uses sensed line quality in deciding which line will be assigned to an incoming call.
